(19) United States
(12) Patent Application Publication
(10) Pub. No.: US 2007/0248518 A1
(43) Pub. Date: Oct. 25, 2007

(54) Desulfurizartion for Simultaneous Removal of Hydrogen Sulfide and Sulfur Dioxide

(75) Inventors: Kwang-Deog Jung, Seoul (KR); Oh-Shim Joo, Seoul (KR); Jun-Woo Oh, Seoul (KR); Eun-Gu Lee, Seongnam-si (KR); Kyungil Choi, Daejeon (KR)

Correspondence Address: ANDERSON, KILL & OLICK, P.C., 1251 AVENUE OF THE AMERICAS, NEW YORK,, NY, 10020-1182, US

(73) Assignee: KIREA INSTITUTE OF SCIENCE AND TECHNOLOGY, SEOUL (KR)

(21) Appl. No.: 11/597,684

(22) PCT Filed: Jun. 8, 2005
(86) PCT No.: PCT/KR05/01717

§ 371 Date: Nov. 21, 2006

(30) Foreign Application Priority Data
Jun. 8, 2004 (KR) 10-2004-0041841

(51) Int. Cl. B01D 53/86

(52) U.S. Cl. 423/222

(57) ABSTRACT

A highly efficient desulfurization method for removing a hydrogen sulfide and a sulfur dioxide simultaneously comprises the step of contacting a gas containing the hydrogen sulfide and the sulfur dioxide with water, or an aqueous solution containing a first heterogeneous catalyst for desulfurization to oxidize the hydrogen sulfide with the sulfur dioxide. 3˜5% sulfur-containing tail gas exhausted from, especially, Claus Process can be treated at a high efficiency of over 99%.

### FIELD OF THE INVENTION

The present invention relates to a highly efficient desulfurizing process for simultaneous removal of hydrogen sulfide and sulfur dioxide.

### BACKGROUND OF THE INVENTION

Hydrogen sulfide (H₂S) is exhausted from oil refineries after HDS (hydrodesulfurization) process. About 95% of H₂S exhausted from HDS process is converted into elemental sulfur through Claus process. Unreacted tail gas still contains H₂S and sulfur dioxide (SO₂) in an amount of about 0.3-1.5% by volume and about 0.15-0.75% by volume, respectively.

Many techniques have been developed to process the tail gas having such composition. Exemplary one is SCOT process, wherein hydrogenation reaction converts remaining SO₂ into H₂S, which is then circulated back into Claus process via the amine absorption/desorption process. Part of H₂S still remaining in SCOT process is oxidized into SO₂ in an incinerator and the concentration thereof is lowered to 250 ppm or less before being exhausted into the air (see Anon, Sulfur, 227 (1993) 39). In SCOT process, however, it is hard to achieve SO₂ concentration of 50 ppm or less without huge capital and operation cost.

There are processes available besides SCOT process such as that of directly oxidizing H₂S at a temperature higher than the condensation temperature of the solid sulfur (see Anon, Sulfur, 231 (1994) 36), or that of selectively converting H₂S into sulfur through a wet process at a room temperature. However, applications of these processes are quite limited due to the problems such as instability of the catalyst.

In addition to these high temperature and middle temperature desulfurization processes, a room-temperature process is also available such as a liquid oxidation-reduction process, wherein H₂S is selectively converted into sulfur at a room temperature. Commercial examples of such process include Stretford process, LO-CAT II process and Bio-SR process.

However, recent trend has been moving toward the iron oxide-based process since Stretford process, with the involvement of vanadia catalyst, may cause environmental problems. The LO-CAT II process employs an iron chelate compound and other chemicals for the stabilization thereof, which can be problematic due to: the requirement of big reactor size with the catalyst concentration of about 500-3000 ppm; loss of catalyst activity by the deposition of iron chelate thereon; excess loss of chemicals during the sulfur recovering process; and low processing efficiency as a result of use of 4 moles of iron chelate compounds for the processing of 1 mole of sulfur.

The reactor size in the Bio-SR process is big as well since the use of ferric sulfate as a catalyst encompasses low processing efficiency of hydrogen sulfide. Further, the pH level inside of the reactor in the Bio-SR process must be maintained at about 1 and several chemicals are needed to control the broth of thiobacillus ferroidans strain, a catalyst for the oxidizing process. In addition, even though it is true that the Bio-SR process incurs less cost in chemicals than the LO-CAT II process, actual operation cost of Bio-SR process is much more than that of the LO-CAT II process if the risk of the biological treatment and operation cost are taken into account.

### SUMMARY OF THE INVENTION

It is, therefore, an object of the present invention to provide a highly efficient desulfurizing process devoid of the problems currently present in the liquid oxidation-reduction process for tail gas treatment and operable in a simple and reliable way at low cost.

To meet with an above-mentioned object, an inventive desulfurization method includes the step of contacting a gas containing the hydrogen sulfide and the sulfur dioxide with a water, or an aqueous solution containing a first heterogeneous catalyst for desulfurization to oxidize hydrogen sulfide with the sulfur dioxide, optionally, under the presence of an oxidizing agent.

The inventive desulfurization method may further include the step of oxidizing the unreacted hydrogen sulfide from the first desulfurization step with an oxidizing agent under the presence of a second heterogeneous catalyst for a second desulfurization.

The first heterogeneous catalyst in the aqueous solution in the first desulfurization step may be the second heterogeneous catalyst coming out of the second desulfurization step.

### BRIEF DESCRIPTION OF DRAWINGS

The above and other objects and features of the present invention will become apparent from the following description of preferred embodiments given in conjunction with the accompanying drawings, in which:

FIG. 1 exemplifies a schematic block diagram of a highly efficient desulfurizing process of the present invention;

FIG. 2 shows a sulfur removing efficiency of a wet oxidation reaction without catalyst conducted in accordance with Example 1;

FIG. 3 illustrates a sulfur removing efficiency of the process of present invention conducted under the presence of a Fe/MgO catalyst in accordance with Example 2;

FIG. 4 depicts the sulfur removing efficiencies of the process of present invention as a function of the ratio between hydrogen sulfide and sulfur dioxide in accordance with Example 3;

FIG. 5 accords the sulfur removing efficiencies of the process of present invention as a function of the concentration of the catalyst slurry in accordance with Example 4;

FIG. 6 describes the sulfur removing efficiencies of the process of present invention as a function of the in-flow rate of the catalyst slurry in accordance with Example 5; and

FIG. 7 shows the sulfur removing efficiencies of the process of present invention as a function of the residence time in accordance with Example 6.

### DETAILED DESCRIPTION OF THE INVENTION

The desulfurization method of the present invention is effective in processing a waste gas, especially those having both H₂S and SO₂. The inventive method can be applied to the processing of a sulfur compound-containing gas generated from a carbon black manufacturing process as well as Claus tail gas from refineries.

The desulfurization method of the present invention is a wet oxidation process for simultaneous removal of H₂S and SO₂ using an autoxidation reaction in an aqueous solution. Unlike other conventional desulfurization methods, there is no need for hydrogenation reaction of SO₂ or amine absorption/desorption process for H₂S separation.

Accordingly, the process can be simple and the sulfur recovery rate may be exceptionally high.

To cope with the problem of catalyst deactivation in a sub-dew point process with a conventional middle temperature catalyst, the wet oxidation process for a selective desulfurization is adopted in the present invention while employing a cheap and effective heterogeneous catalyst. The present invention addresses both problems present in a conventional liquid oxidation-reduction process: i.e., the need for the injection of chemicals for the control of pH; and the need for the prevention of the sedimentation during the reaction of organic metal catalyst.

Low temperature wet autoxidation process of the present invention enabling simultaneous processing of hydrogen sulfide and sulfur dioxide is a breakthrough process which significantly reduced an amount of polluting gas exhausted.

The inventive desulfurization method involves the crucial step of wet autoxidation process, wherein SO₂ contained in the reaction gas works as an oxidizing agent and continuously reacts with H₂S through a wet process at room temperature, rendering most of H₂S and SO₂ to be removed at the same time. After this step, the remaining unreacted H₂S from the first desulfurization step may further be converted into sulfur under the presence of an oxidizing agent and a catalyst through a wet oxidation process.

Preferred embodiments of the present invention are described in detail with reference to the accompanying drawings below.

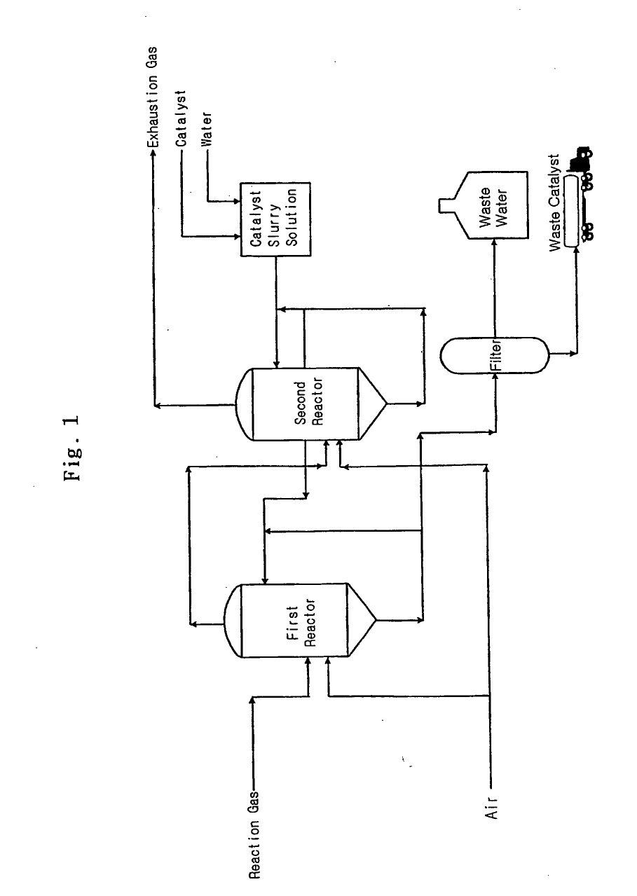

Highly efficient desulfurization process of the present invention is exemplarily shown in FIG. 1. As shown in FIG. 1, a catalyst slurry solution is supplied into a second reactor first before being fed into a first reactor while a reaction gas is supplied in a reverse direction, i.e. from the first to the second reactor, where it gets exhausted. Only catalyst is needed during the above-mentioned reactions in the first and second reactors and neither chemicals nor temperature control devices are required. Perhaps, installation of a heat exchanger is necessary to control the temperature rise at below 60° C., temperature rise being caused by the heat of, reaction or heat generated in a circulation pump or blower.

In the first desulfurization step, a gas containing hydrogen sulfide and sulfur dioxide is introduced into the first reactor for desulfurization reaction with the catalyst slurry that comes out of the second reactor. Next, the gas coming out of the first desulfurization step via the top of the first reactor is introduced into the second reactor. The slurry discharged from the bottom of the first reactor is filtered and subjected to an environmental processing: waste disposal processing for catalyst and waste water disposal for the filtered waste water. The amount of waste water discharged from the process of the present invention is very small to be 1 ton or less for the processing of each ton of sulfur.

In the present invention, it is preferable that the reaction gas contains more sulfur dioxide, an oxidizing agent, than hydrogen sulfide.

As described above, the desulfurization reaction can be performed, as needed, by continuously supplying water instead of recycling catalyst slurry. That is, the first desulfurization reaction may be performed by processing the reaction gas with either water or catalyst slurry solution. When using pure water, however, the processing solution can be acidic and its emulsion form renders the operation to be difficult although processing efficiency may be higher. Accordingly, it is preferable that a small amount of an alkali-based catalyst is added to water. The reaction efficiency can be raised through a catalytic scrubbing by introducing a catalyst as a slurry form to effectively separate solids including sulfur from the reaction solution.

The catalyst for use in the desulfurization step(s) of the inventive method is a transition metal or an oxide thereof supported as an active metal on an alkali metal oxide or an alkaline earth metal oxide as a support, preferably CaO or MgO. It is preferable that the transition metal, as the active metal, is selected from the group consisting of iron (Fe), molybdenum (Mo), vanadium (V), cobalt (Co), manganese (Mn), copper (Cu), and a mixture thereof.

The amount of the active metal loaded is in the range of 0.1-60% by weight, preferably 0.3-20% by weight based on the weight of the support. The active metal may be used as a single kind or as a mixture of two or more kinds.

The reaction gas to be desulfurized in accordance with the present invention is, e.g., a conventional tail gas containing H₂S and SO₂ maintained at a temperature of 130-220 C. and the reactor can be, e.g., a catalytic scrubber, slurry stirred reactor or half-dry type catalytic packed bed reactor. Accordingly, the first reactor can be a slurry reactor, fixed bed reactor or fluidized reactor as well as a scrubber.

Also, it may be preferable to fill the first reactor with a packing material to enhance gas-liquid contact. The packing material can be any material for use in conventional scrubber such as a Pall ring.

To prevent precipitation of sulfur or catalyst, a circulation pump for stirring may be equipped on the bottom of the reactor. Alternatively, other direct stirring means may be employed.

In the first reactor, an oxidizing agent such as air, oxygen, ozone or hydrogen peroxide may be optionally introduced.

Also, it is preferable to install a diffuser at the bottom of the first reactor so that the reaction gas containing hydrogen sulfide and sulfur dioxide has an effective gas-liquid contact with the processing solution.

A concentration of the catalyst in the catalyst slurry for use in the first desulfurization step is in the range of 0.01-10% by weight. The first desulfurization step can be operated at 0-100° C., preferably at 5-50° C.

To raise efficiency of the first desulfurization step in the first reactor, the desulfurized product after the first desulfurization step may itself be recycled back into the first reactor.

According to the present invention, most of SO₂ in the reaction gas is removed in the first reactor through the first desulfurization step. Some unreacted H₂S is introduced into the second reactor with an oxidizing agent for oxidizing processing therein under the presence of catalyst.

The second reactor is preferably a slurry reactor or fluidized bed reactor but, like the first reactor, a catalytic scrubber may also be used. The second reaction may be operated in a continuous or batch type.

Referring to FIG. 1, in the second desulfurization step, the first desulfurized product from the first reactor is introduced into the second reactor to be in contact with a separately introduced catalyst slurry and an oxidizing gas for the oxidizing processing therein. The desulfurization efficiency can be improved by exhausting the desulfurized gas from the top of the second reactor and recovering the desulfurizing product from the bottom of the second reactor to recycle it back into the second reactor.

The oxidizing agent for use in the second desulfurization step may be air, oxygen, ozone or hydrogen peroxide. The higher the partial pressure of the oxidizing agent gas becomes, the better the sulfur compound removing efficiency is. In case of oxygen, for instance, the reaction efficiency is high if the oxygen is supplied in a way that its partial pressure generally exceeds an equivalent of the total flow rate of hydrogen sulfide and sulfur dioxide.

The processing capacity of catalyst for wet oxidizing reaction of H₂S in the second reactor increases in proportion to 0.6 power of the partial pressure of the oxygen when using oxygen as an oxidizing agent. When oxygen partial pressure is equivalent to that in the air, sulfur removing capacity is in the range of 0.7-2 g_{sulfur}/g_{catalyst} depending on the dispersion of an active metal component of the catalyst, generally iron component.

The concentration of catalyst in the slurry for use in the second desulfurization step is in the range of 0.01-30% by weight, preferably 0.05-5% by weight. The oxidizing reaction using the catalytic process of the present invention can be operated at 0-100° C., preferably at 5-50° C.

According to the present invention, in the second reactor, depending on the processing conditions, maximum 99.99% conversion of the sulfur compound in the gas processing can be achieved.

As mentioned previously, the inventive process is a low temperature wet oxidation reaction and, accordingly, is devoid of operational risks like those found in high temperature desulfurizing process. Further, the inventive process is easy to operate since, unlike liquid oxidation-reduction reaction, a buffer solution for maintaining pH is not needed as a heterogeneous catalytic process. Also, the inventive process enables simultaneous removal of hydrogen sulfide and sulfur dioxide and 99% or more selectivity to sulfur can be achieved. The desulfurization method of the present invention is an environmentally friendly technique devoid of the usage of chemicals and eliminates most of the problems existing in the operation of conventional liquid phase oxidation-reaction process such as the decomposition of a chelating agent and the formation of salt.

The following examples are given for the purpose of illustration only and are not intended to limit the scope of the invention.

### Example 1

Example 1 shows the effect of simultaneous removal of hydrogen sulfide and sulfur dioxide in batch type wet oxidation reaction without using catalyst.

1.5 Liter of water was put into a stirring type reactor, where hydrogen sulfide, sulfur dioxide and air were introduced through a perforated diffuser located at the bottom of the reactor in a way that flow rate of hydrogen sulfide was 10 ml/min, that of sulfur dioxide was 5 ml/min and that of air as an oxidizing agent was 100 ml/min. After the reaction, the product gas was analyzed with gas chromatography and the results were converted into the removing efficiency with the following equation.

$$Removing efficiency ( \% ) = \frac{{Concentration}_{in the reaction gas} - {Concentration}_{in the product gas}}{{Concentration}_{in the reaction gas}} ⨯ 100$$

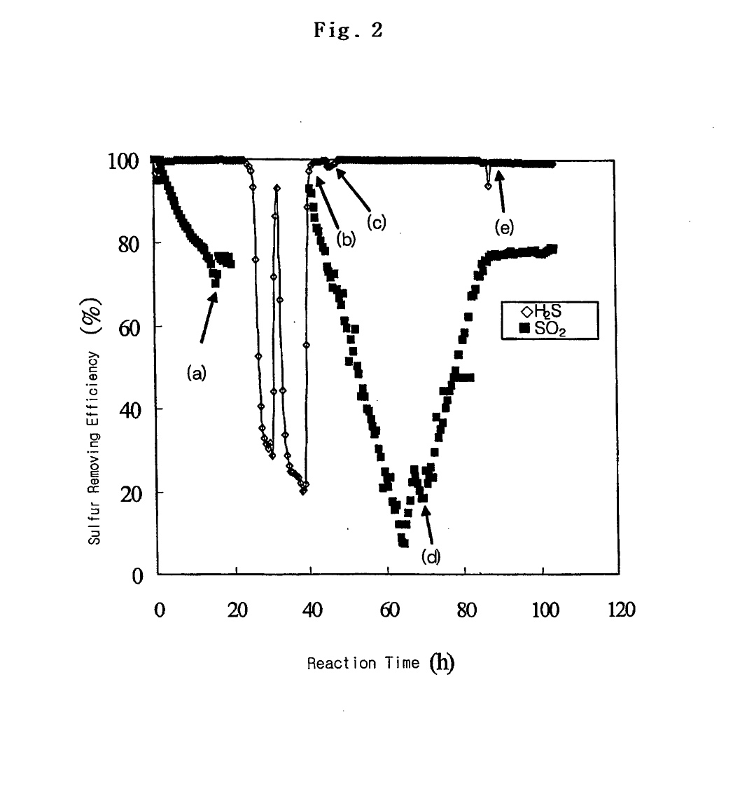

The sulfur removing efficiency is shown in FIG. 2 as a function of reaction time. In FIG. 2, (a), (b), (c), (d) and (e) indicate the point when SO₂ was off, SO₂ was on, H₂S was off, H₂S was on and when oxidizing agent was changed to oxygen, respectively.

As shown in FIG. 2, it was ascertained that removing efficiency of hydrogen sulfide remarkably increases when sulfur dioxide is introduced.

### Example 2

The procedure of Example 1 was repeated except that 3 g of 6% by weight Fe/MgO catalyst was employed in Example 2. 6% by weight Fe/MgO catalyst was prepared by dispersing 20 g of MgO in 200 ml of water, adding 1 N iron nitrate solution thereto so that Fe becomes 6% by weight in relation to MgO, and then drying and baking the resultant at 450° C.

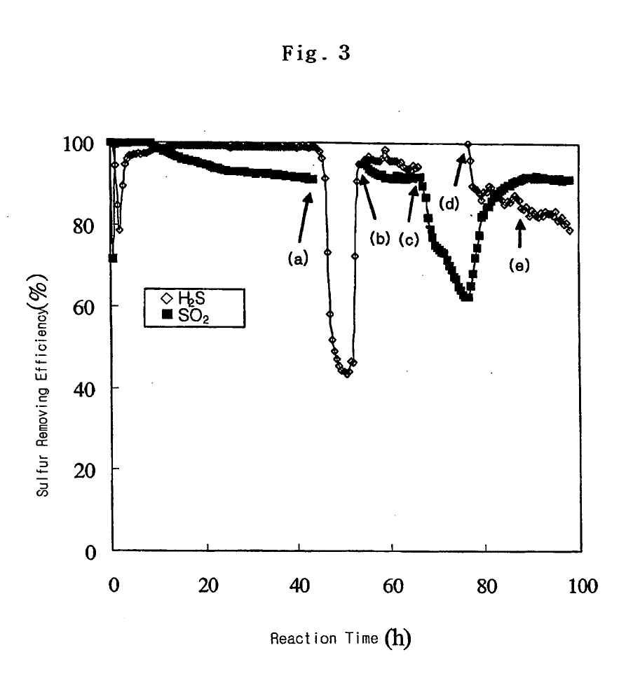

The results are shown in FIG. 3. In FIG. 3, (a), (b), (c), (d) and (e) indicate the point when SO₂ was off, SO₂ was on, H₂S was off, H₂S was on and when oxidizing agent was changed to nitrogen, respectively.

FIG. 3 shows that both removing efficiency and simultaneous removing efficiency of hydrogen sulfide and sulfur dioxide are much higher in Example 2 when Fe/MgO catalyst was used than in Example 1 when no catalyst was used. After (e) point when oxidizing agent was changed to nitrogen, removing efficiency of hydrogen sulfide and sulfur dioxide gradually decreased.

### Example 3

3 g of 6% by weight Fe/MgO catalyst was employed and same desulfurization step was repeated as in Example 2 except that reaction gas ratio between hydrogen sulfide and sulfur dioxide was varied at 5:5, 5:15 and 10:5, and that air was used as an oxidizing agent while total gas flow rate being fixed at 110 ml/min.

As a result, the removing efficiency of hydrogen sulfide was high when the concentration of sulfur dioxide was higher than that of hydrogen sulfide as shown in FIG. 4. This means that sulfur dioxide plays an important role as an oxidizing agent in the inventive desulfurization reaction. Specifically, sudden drop in the removing efficiency was observed at the beginning of the reaction when the ratio between hydrogen sulfide and sulfur dioxide was 5:5 or 10:5, which is indicative of the presence of an induction period in the inventive desulfurization reaction.

### Example 4

In Example 4, the removing efficiency of hydrogen sulfide was checked for wet oxidizing reaction in a continuous flow stirred tank reactor (CSTR).

Specifically, 1.5 L of a catalyst slurry solution was put into a CSTR while feeding a reaction gas thereinto, flow rate of each constituent of the reaction gas being 10 ml/min of hydrogen sulfide, 5 ml/min of sulfur dioxide and 95 ml/min of air. Removing efficiency in the CSTR was observed. At this time, the concentration of the catalyst slurry was varied at 0 ppm, 2000 ppm, 5000 ppm and 10000 ppm while the flow rate of the catalyst slurry being fixed at 200 ml/h.

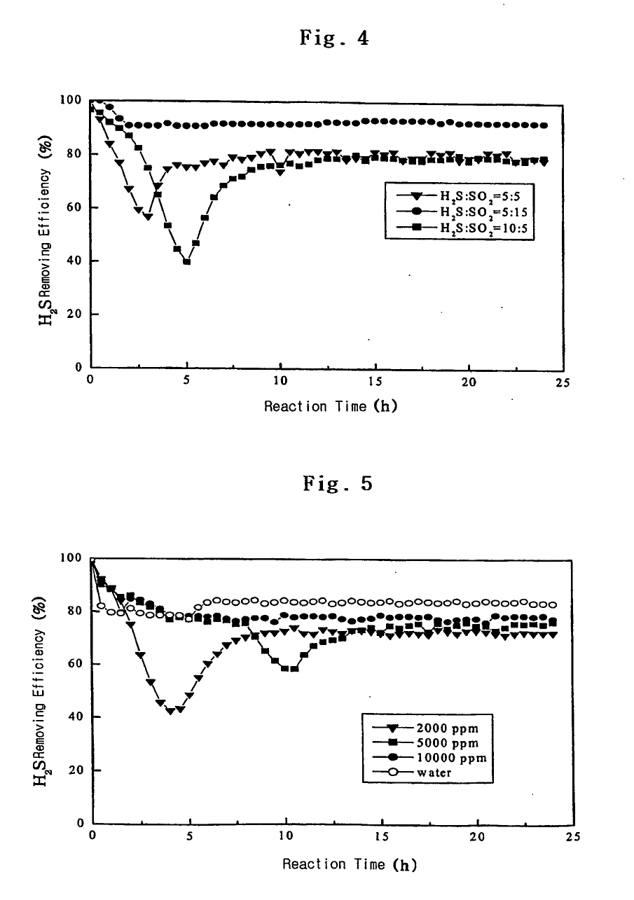

As shown in FIG. 5, the induction period was observed as in the batch type desulfurization reaction of Example 3. Further, it can be seen that the intensity decreases with the increase in the catalyst concentration, and the hydrogen sulfide removing efficiency is maintained at a certain level after some time.

### Example 5

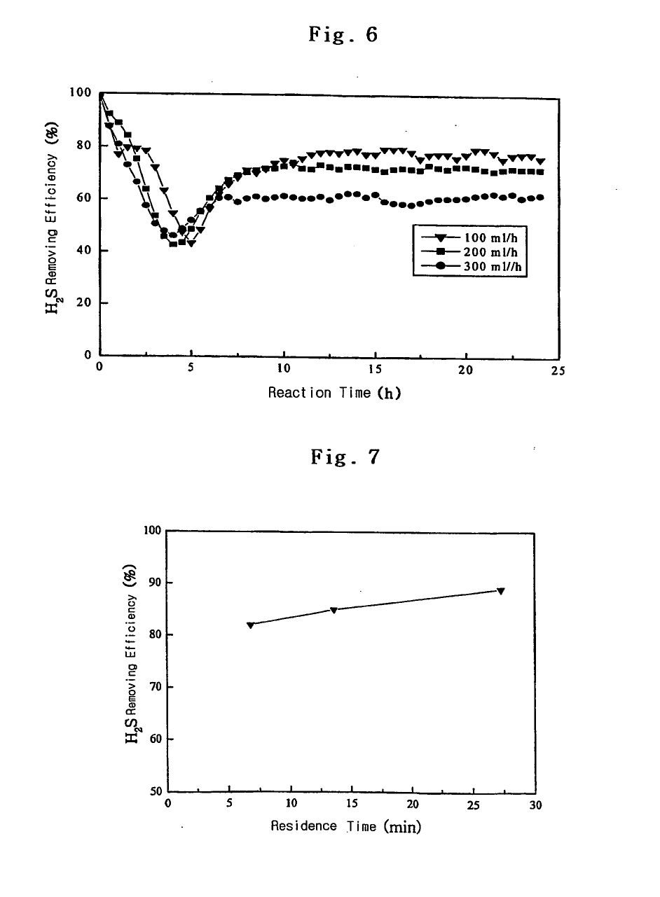

The procedure of Example 4 was repeated except that the flow rate of the catalyst slurry was varied at 100 ml/h, 200 ml/h and 300 ml/h. Results are shown in FIG. 6.

### Example 6

The procedure of Example 4 was repeated except that the residence time of the reaction gas was varied.

As shown in FIG. 7, the removing efficiency increased as the residence time increases.

### Example 7

Reactor system was installed in a way as shown in FIG. 1. Reaction gas temperature was 150° C. Flow rates of H₂S, SO₂, steam and nitrogen were 20 l/min, 10 l/min, 500 l/min and 1470 l/min, respectively. Concentrations of H₂S and SO₂ in the reaction gas were 1% and 0.5%, respectively.

After the reaction, H₂S and SO₂ concentrations at the outlet were found to be less than 3 ppm and 0.1 ppm, respectively. That is, the removing efficiency of the sulfur compound was found to be more than 99.98%.

### Reference Example 1

A reaction gas was supplied in the same manner as in Example 1 except that the reaction gas lacked in SO₂ and only contained H₂S. The amount of H₂S removed in a wet catalytic reaction was measured with various catalyst components at the flow rates of H₂S and air of 10 ml/min and 100 ml/min, respectively. Catalysts were manufactured by the method described in Example 2. The sulfur compound processing capacity of the catalyst was calculated by measuring the amount of processed sulfur compound per 1 g of catalyst up to the point when the processing efficiency reaches 90%, and the results are shown in Table 1.

TABLE 1

| | Sulfur compound processing |
|---|---|
| | capacity of the catalyst |
| Catalyst | [g_{sulfur}/g_{catalyst}] |
| 6 wt% Fe/MgO | 1.3 |
| 20 wt % Fe/MgO | 1.0 |
| 6 wt % V/MgO | 1.1 |
| 6 wt % Mo/MgO | 0.9 |
| 6 wt % Cu-6 wt % Fe/MgO | 0.7 |
| 6 wt % Mn/MgO | 0.7 |
| 6 wt % Mn-6 wt % Fe/MgO | 0.7 |

From Table 1, it can be seen that several kinds of heterogeneous catalyst can be employed in the desulfurization process of the present invention.

While the invention has been shown and described with respect to the preferred embodiments, it will be understood by those skilled in the art that various changes and modification may be made without departing from the spirit and scope of the invention as defined in the following claims.

1. A desulfurization method for simultaneously removing a hydrogen sulfide and a sulfur dioxide, comprising the step of contacting a gas containing the hydrogen sulfide and the sulfur dioxide with water, or an aqueous solution containing a first heterogeneous catalyst for desulfurization to oxidize the hydrogen sulfide with the sulfur dioxide.

2. The desulfurization method of claim 1, further comprising the step of oxidizing unreacted hydrogen sulfide from the first desulfurization step with an oxidizing agent under the presence of a second heterogeneous catalyst for a second desulfurization.

3. The desulfurization method of claim 2, wherein the first heterogeneous catalyst in the aqueous solution is the second heterogeneous catalyst coming out of the second desulfurization step.

4. The desulfurization method of claim 3, wherein the reactors for carrying out the first and second steps are selected from the group consisting of a catalytic scrubber, a slurry reactor, a fixed-bed reactor and a fluidized-bed reactor.

5. The desulfurization method of claim 4, wherein the first desulfurization step is carried out in the slurry reactor or the fluidized-bed reactor and the second desulfurization step is carried out in the catalytic scrubber.

6. The desulfurization method of claim 3, wherein the second catalyst contains a transition metal or an oxide thereof supported on an alkali metal oxide or an alkaline earth metal oxide support.

7. The desulfurization method of claim 6, wherein the transition metal is at least one of the metals selected from the group consisting of iron, molybdenum, vanadium, cobalt, manganese and copper.

8. The desulfurization method of claim 6, wherein the support is MgO or CaO.

9. The desulfurization method of claim 6, wherein an amount of the transition metal or the oxide thereof supported is in the range of 0.1-60% by weight based on the weight of the support.

10. The desulfurization method of claim 3, wherein the desulfurization steps are carried out at a temperature range of 0-100° C.

11. The desulfurization method of claim 3, wherein the oxidizing agent includes at least one agent selected from the group consisting of air, oxygen, ozone and hydrogen peroxide.

12. The desulfurization method of claim 3, wherein the gas containing the hydrogen sulfide and the sulfur dioxide is a tail gas exhausted from oil refineries after Claus process or an exhaust gas from a carbon black manufacturing process.

13. The desulfurization method of claim 1, wherein the oxidation step is carried out under the presence of an oxidizing agent.
